(19) United States
(12) Patent Application Publication
(10) Pub. No.: US 2003/0102608 A1
(43) Pub. Date: Jun. 5, 2003

(54) Flame cutting device

(76) Inventor: Anton W. Hubert, Monchengladbach (DE)

Correspondence Address: ROBERT & MILLER, TEN THOUSAND BUILDING, SUITE 112, 10000 SHELBYVILE ROAD, LOUISVILLE, KY, 40223-2950, US

(21) Appl. No.: 10/001,230

(22) Filed: Dec. 4, 2001

(51) Int. Cl. B23K 7/10

(52) U.S. Cl. 266/58

(57) ABSTRACT

A flame cutting device is disclosed which includes a cutting torch mounted in a housing on a torch carriage, the carriage, in turn, being movably mounted on a torch carriage support for back and forth movement along the support over and across a cutting table. The torch carriage support is movably mounted on a pair of running gears disposed on a pair of rails located along opposite sides of the table for movement of the torch carriage and torch carriage support back and forth over and along the cutting table perpendicular to the movement of the torch carriage on the support. The torch is mounted on an intermediate support element which can swing around a first axis and the support element is mounted on the torch carriage, which carriage can swing about a second axis perpendicular to the first axis, such that the tip of the torch can be moved between a vertical position and a tilted position relative to the cutting table.

The invention relates to a flame cutting device comprised of a torch carriage support, which can be moved via a first drive mechanism in a first direction parallel to a cutting table, and of at least one torch carriage, which can be moved on the torch carriage support via a second drive mechanism in a second direction parallel to the cutting table; and a torch tip designed to generate a flame cutting stream is arranged on the torch carriage by means of a torch mounting device, and the latter comprises a torch support that is mounted on an intermediate support element with the ability to swing around a first axis, and the intermediate support element is mounted on the torch carriage with ability to swing around a second axis, and the axes extend in such a way in relation to the cutting table that, when swung, the torch tip can be brought from its vertical position relative to the cutting table to a tilted position and vice versa.

Flame cutting devices are used to cut sheet metal plates by way of a flame cutting stream. The flame cutting stream is generated in a torch tip, which can be realized as a flame cutter, a plasma cutter, a laser cutter etc.

A flame cutting device has a cutting table on which the work piece that is to be cut, generally a flat plate, can be placed and, if necessary, fastened. The cutting table usually extends in a horizontal plane. A torch carriage support with one or more torch carriages is located above the cutting table (compare DE 295 20 483.4). Each torch carriage is equipped with a torch tip. Using an electric drive mechanism, the torch carriage or carriages are movable on rails, in particular in the direction of the longitudinal axis of the torch carriage support and parallel to the plane of the cutting table.

The torch carriage support is normally realized as bridge-like. By way of a running gear it is supported on both sides of the cutting table on rails which extend crosswise in relation to the longitudinal axis of the torch carriage support, whereby it is possible to move the torch carriage support, together with the torch carriage or carriages, in this direction along the cutting table. Thus, in conjunction with the mobility of the torch carriage it is possible to target any point on the cutting table for the cutting action of the work piece. This is accomplished by means of a control device, which is equipped with an operational sequence program that automatically controls the two drive mechanisms in correspondence with the desired cutting sequence. The operational sequence program may also be altered by inputting the proper data for effecting different cutting sequences.

It is not absolutely necessary for the torch carriage support to be supported on both sides. For smaller flame cutting devices, the support may also be realized as a free projection. In this instance, the device is movably guided only on one side of the cutting table, in particular on correspondingly designed guide apparatuses (compare DE 297 22 240.6). For smaller flame cutting devices, this design is especially recommended because it requires only a minimal amount of space.

The torch tip is held in position on the torch carriage by way of a torch mounting device. The torch mounting device is movable in a vertical direction in relation to the cutting table, thereby allowing for the proper adjustment of the distance of the torch tip in relation to the work piece. In general, the torch tip is positioned in such a way as to generate a vertical flame cutting stream in relation to the cutting table.

Sometimes, however, it is necessary to generate a diagonal bevel on the edges of the work piece that is to be cut even during the cutting process. To accomplish this, the torch tip must be placed at an angle in order to generate a flame cutting stream that will impact the work piece at a corresponding angle. The current state of the art provides for a torch mounting device where the torch tip is fastened to a torch support, which is mounted on an intermediate support element with the ability to swing around a first axis while the intermediate support element is positioned on the torch carriage in such a way that it has the ability to swing around a second axis (compare DE 295 20 482.6). The two axes are perpendicular in relation to each other and extend in a plane that is parallel in relation to the cutting table. Using this type of torch mounting device, it is possible to position the torch tip at any angle.

The disadvantage of this type of a torch mounting device is that the angled position of the torch tip must be adjusted by hand and each time the angled position must be changed it is necessary to interrupt the cutting process. This is very time-consuming. Moreover, there exists a risk of injury for the operator due to touching of hot components on the torch tip and the work piece.

It is, therefore, the subject-matter of the present invention to realize a flame cutting device of the type described at the outset with an adjustment process for the torch tip that is considerably faster and eliminates any injury risk to the operator.

According to the invention, this objective is achieved by envisioning servomotors in order to effect the swinging of the torch support and the intermediate support element; the servomotors are connected to an electric or electronic control device that activates the servomotors. Therefore, it is the object of the invention to adjust the torch tip using servomotors that are activated by way of a control device. Thus, the operator is able to use the control device to adjust and change the angle of the torch tip, thereby eliminating the risk of coming into contact with hot components of the torch or of the work piece; furthermore, it is not necessary at all, or it is only briefly necessary to interrupt the cutting process.

It is particularly advantageous for the control device to be equipped with an operational sequence program that activates the servomotors in relation to the progress of the cutting process. If the same parts are consistently be cut, it is possible to install this sequence program permanently. However, the flame cutting device can also be used in a more flexible fashion, provided it is possible to input data for the sequence program via an input interface. The input data can be used to adjust the position of the torch tip, preferably already at the start of the cutting process, depending on the progress of the cutting process. In this process, the control device should be part of an overall control device that can be used to activate the drive mechanisms for the torch carriage support and the torch carriage, while the control device and the overall control device utilize a joint operational sequence program. By inputting the necessary data regarding the cutting process and the respective positions of the torch tip in relation thereto in advance it is possible to automate the entire cutting process, meaning that the operator no longer needs to be present during the cutting process.

Any suitable motor can be used as a servomotor. Primarily, these can be electric stepping motors. But pneumatic servomotors, e.g. in the form of piston-cylinder units, are also possible.

If electric servomotors are used, curved toothed rings can be envisioned on the torch support and the torch carriage in which the servomotors are engaged. In this case, it is useful if the torch tip is mounted on the intermediate support element, and the intermediate support element itself is mounted on curved guide elements, with the intermediate support element most suitably being mounted on the curved guide elements with both of its ends. Using such curved guide elements, the axis can be placed as desired.

Regarding the arrangement of the first and second axes, it is advantageous, as is known in the current state of the art, if the second axis is vertical in relation to the plane in which the first axis can be swung. The plane in which the first axis is able to swing should be vertical in relation to the cutting table. It is especially advantageous for the second axis to extend below the lower end of the torch tip, in particular, most suitably at a distance that corresponds to the distance envisioned between the lower end of the torch tip and the work piece. The same should apply for the first axis. This type of realization has the advantage that if the position of the torch tip is changed, the distance in relation to the work piece is not affected.

The torch tip is usually connected to a feed pipe that supplies the system with the power carrier; in the case of a plasma torch this involves e.g. various gases. The weight of the feed pipe affects the guidance of the torch tip and the servomotors. To relieve stress on the servomotors, the invention envisions that the feed pipe is equipped with a weight load relief apparatus, which can be comprised e.g. of a counterweight or of a spring suspension. A corresponding weight load relief apparatus is most suitably also envisioned for the intermediate support element in order to relieve stress from its guide element and the servomotor.

The drawings show the invention in greater detail utilizing a schematic depiction of an embodiment. Show are in:

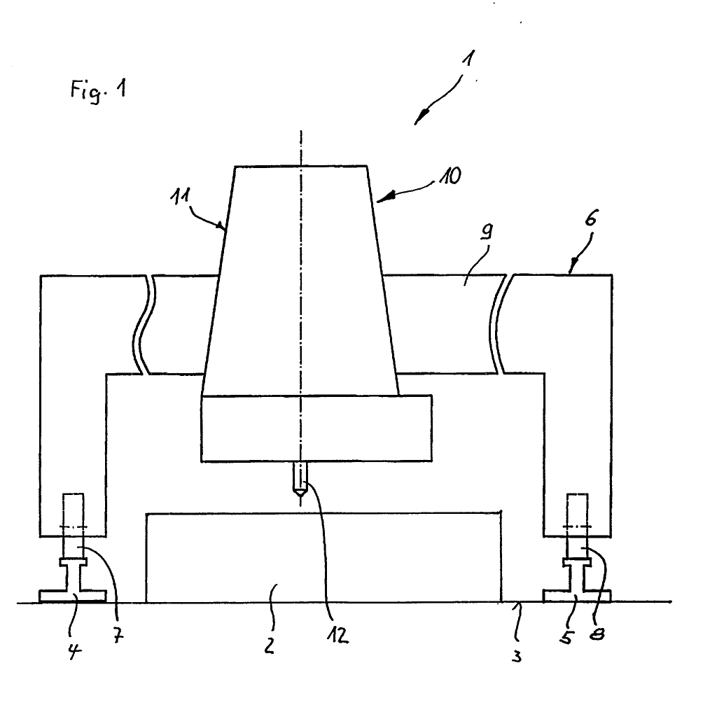

FIG. 1 a front view of a flame cutting device and in

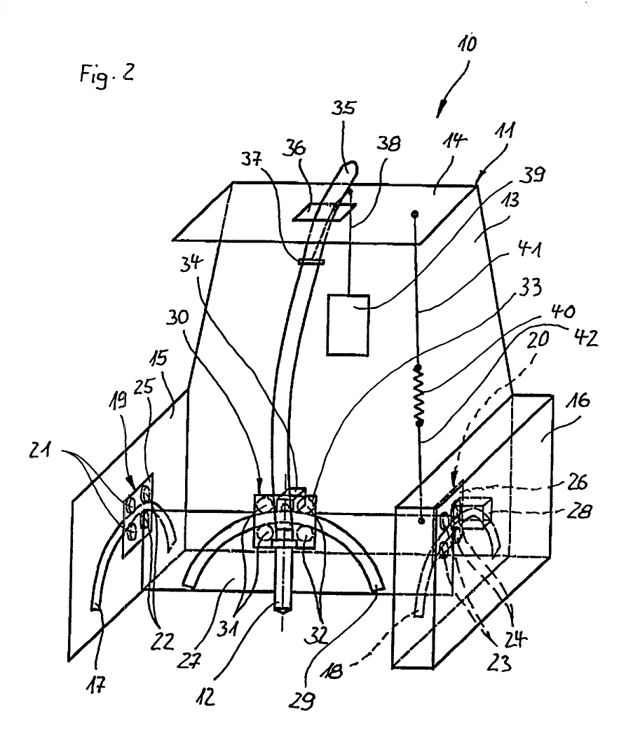

FIG. 2 a perspective view of the torch carriage of the flame cutting device in accordance with FIG. 1.

The flame cutting device 1, depicted in FIG. 1, has a cutting table 2, shown here only as an outline, which is positioned in a stationary position on a floor 3 with an the upper surface onto which a work piece can be placed and, if necessary, fastened. Rails 4, 5 that are supported on the floor 3 extend along both sides of the cutting table 2. An overhead arc-shaped torch carriage support 6, equipped on both sides with running gears 7, 8, rests on the rails 4, 5. By way of the running gears 7, 8, the torch carriage support 6 is movable along the rails 4, 5, i.e. in a vertical direction in relation to the plane of the drawing, and the actual moving process is implemented by means of an electric motor drive mechanism.

The torch carriage support 6 has a cross support 9 that extends parallel to the surface of the cutting table 2, and a torch carriage 10 is positioned on it by way of rails, not shown here in more detail. The rails extend lengthwise along the cross support 9, which means the plane of the drawing. Therefore, the torch carriage 10 is guided along the longitudinal axis of the cross support 9, i.e. in a crosswise direction, and a second electric motor drive mechanism is envisioned for moving the torch carriage 10. Thus, the direction of movement of the torch carriage 10 and of the torch carriage support 6 are perpendicular in relation to one each other, extending in a horizontal plane.

The torch carriage 10 is has a torch carriage housing 11. The plasma torch tip 12 protrudes on the bottom side of said housing. The torch carriage housing 11 and the plasma torch tip 12 are movable in a vertical direction—not illustrated here in more detail—thereby allowing for the adjustment of the distance between the plasma torch tip 12 and the cutting table 2 in order to accommodate the respective thickness of the work piece that is positioned on the cutting table 2.

In FIG. 2, the torch carriage housing 11 is shown as partially opened. Visible are a rear wall of the housing 13, an upper wall of the housing 14, a left side wall of the housing 15 and on the right side a rectangular housing box 16.

A curved guide 17, 18 is positioned, respectively, on the inside of the left wall of the housing 15 and in the right housing box 16. The curved guides 17, 18 have radius center points whose connection constitutes a horizontal axis extending parallel in relation to the cross support 9 below the lower end of the plasma torch tip 12. Running gears 19, 20 are running on the curved guides 17, 18, and each of them is equipped with two pairs of rollers 21, 22, 23, 24, respectively, that enclose the curved guides 17, 18 and are mounted on running gear supports 25, 26. The running gear supports 25, 26 are connected by way of a plate-shaped intermediate support element 27. Consequently, the intermediate support element 27 is guided via the running gears 19, 20 on the curved guides 17, 18, in particular in such a way that is has the ability to swing around the above-mentioned horizontal axis.

A toothed ring—not shown in more detail—that has the same radius as the curved guide 18 is mounted on the curved guide 18 that is arranged in the housing box 16. A stepping motor 28 is arranged on the right side running gear support 26 whose drive shaft ends in a toothed gear that meshes with the toothed wheel. Consequently, when the stepping motor 28 is activated, the intermediate support element 27 is moved along the curved guides 17, 18 via the running gears 19, 20, executing a swinging motion around the horizontal axis that is defined by the curved guides 17, 18.

Another curved guide 29 is attached on the intermediate support element 27, whose radius is dimensioned in such a way that the center point is situated below the lower end of the plasma torch tip 12, in particular, preferably at a distance that corresponds to the envisioned distance in relation to a work piece positioned on the cutting table 2. A running gear 30 is guided on the curved guide 29, which has—like the running gears 19, 20—two pairs of rollers 31, 32 that enclose the curved guide 29 on both sides respectively. The pairs of rollers 31, 32 are positioned on a running gear support 33 that serves to fasten the plasma torch tip 12.

The curved guide 29—like the curved guide 18—is equipped with a, in terms of its curve, congruent toothed ring, which is not illustrated here. A stepping motor 34 is mounted on the running gear support 33 whose pinion drive meshes with the toothed ring. Consequently, by activating the stepping motor 34, the running gear 30 can be moved along the curved guide 29, thereby causing the plasma torch tip 12 to be swung in the plane of the curved guide 29.

The upper end of the plasma torch tip 12 is connected to a feed pipe 35 that combines feed lines for the operation of the plasma torch tip 12. The feed pipe 35 exits through an opening 36 in the upper wall of the housing 14 continuing thereafter in a way that is known in the art. Somewhat below the upper wall of the housing 14, a mounting ring 37 is fastened to the feed pipe 35 that is connected to a counterweight 39, in particular by way of a wire 38 that extends upward at first and is then redirected downward. The counterweight 39 relieves the running gear 30 of the considerable weight load from the feed pipe 35 in order to prevent excess stress on the stepping motor 34, especially during the movement of the running gear 30 from a position at one end of the curved guide 29.

A weight relief apparatus is also envisioned for the intermediate support element 27, consisting of a helical spring 40 that is connected, on the one hand, via the wire sections 41, 42 to the intermediate support element 27 and, on the other hand, to the upper wall of the housing 14. If the two running gears 19, 20 are moved in the direction of the ends of the curved guides 17, 18, the helical spring 40 is stretched making it easier for the stepping motor 28 to move out of these positions and back to the center position.

A control device, not shown in more detail, is responsible for controlling the drive mechanisms for moving the torch carriage support 6 and the torch carriage 10 as well as for controlling the stepping motors 28, 34. An operational sequence program is installed in this control device that can be programmed by way of the proper data input via an input keypad in such a way that the cutting process for cutting out a certain work piece from a plate, positioned on the cutting table 2, is done fully automatically. The data defining the course of the cutting edge, and thereby the activation of the drive mechanisms for the torch carriage support 6 and the torch carriage 10, is input before the beginning of the cutting process. Data determining the bevel angle on the cutting edge over the course of the cutting process, and thereby the activation of the stepping motors 28, 34, is also input.

A vertical cut is simplest. In this instance, the plasma torch tip 12 remains in its vertical position, i.e. the running gears 19, 20, 30 are moved to the center of the curved guides 17, 18, 29 via the corresponding triggering of the stepping motors 28, 34, as shown in FIG. 2. If a diagonal cutting bevel is to be realized, the two stepping motors 28, 34 are triggered in such a way as to ensure that the plasma torch tip 12 will maintain the envisioned angle until the work piece is fully cut out, even if the direction of the cutting edge is changed. The operational sequence programming can also be influenced to realize different cutting bevels along the circumference of the work piece that is to be cut out.

1. Flame cutting device (1) comprised of a torch carriage support, which can be moved via a first drive mechanism in a first direction parallel to a cutting table (2), and of at least one torch carriage (10), which can be moved on the torch carriage support (6) via a second drive mechanism in a second direction parallel to the cutting table (2); and a torch tip (12) designed to generate a flame cutting stream is arranged on the torch carriage by means of a torch mounting device, and the latter comprises a torch support (30) that is mounted on an intermediate support element (27) with the ability to swing around a first axis, and the intermediate support element is mounted on the torch carriage (10) with the ability to swing around a second axis, and the axes extend in such a way in relation to the cutting table that, when swung, the torch (12) tip can be brought from its vertical position relative to the cutting table (2) to a tilted position and vice versa wherein servomotors (28, 34), which are connected to an electric or electronic control device for the activation of the servomotors (28, 34), are envisioned for the swinging action of the torch support (30) and the intermediate support element (27).

2. Flame cutting device as claimed in claim 1 wherein the control device is equipped with an operational sequence program that is used to activate the servomotors (28, 34) depending on the progress of the cutting process.

3. Flame cutting device as claimed in claim 2 wherein data for the operational sequence program can be input via an input interface, thereby allowing for the adjustment of the position of the torch tip (12) depending on the progress of the cutting process.

4. Flame cutting device as claimed in claim 2 or claim 3 wherein the control device is part of an overall control device that can be used to activate the drive mechanisms, and [wherein] the control device and overall control device have a common operational sequence program.

5. Flame cutting device as claimed in one of the claims 1 to 4 wherein the servomotors (28, 34) are realized as pneumatic or electric [motors].

6. Flame cutting device as claimed in claim 5 wherein the servomotors are realized as stepping motors (28, 34).

7. Flame cutting device as claimed in one of the claims 1 to 6 wherein curved toothed rings are envisioned on the torch support (30) and on the torch carriage (10) that engage in the servomotors (28, 34).

8. Flame cutting device as claimed in one of the claims 1 to 7 wherein the torch tip (12) is mounted on the intermediate support element (27) on a curved guide (29).

9. Flame cutting device as claimed in one of the claims 1 to 8 wherein the intermediate support element (27) is mounted on at least one curved guide (17, 18).

10. Flame cutting device as claimed in claim 9 wherein the intermediate support element (27) is mounted with both of its ends on curved guides (17, 18).

11. Flame cutting device as claimed in one of the claims 1 to 10 wherein the second axis is vertical in relation to the plane in which the first axis can be swung.

12. Flame cutting device as claimed in one of the claims 1 to 11 wherein the plane in which the first axis can be swung is vertical in relation to the cutting table (2).

13. Flame cutting device as claimed in one of the claims 1 to 12 wherein the second axis extends below the lower end of the torch tip (12).

14. Flame cutting device as claimed in one of the claims 1 to 13 wherein the first axis extends below the lower end of the torch tip (12).

15. Flame cutting device as claimed in one of the claims 1 to 14 wherein the torch tip (12) is connected to a feed pipe (35), and wherein the feed pipe (35) is equipped with a weight relief apparatus (39).

16. Flame cutting device as claimed in one of the claims 1 to 15 wherein the intermediate support element (27) is equipped with a weight relief apparatus (40).

17. Flame cutting device as claimed in claim 15 or claim 16 wherein the weight relief apparatus is comprised of a counterweight (39) and/or a spring suspension (40).
